(19) United States
(12) Patent Application Publication
(10) Pub. No.: US 2007/0003770 A1
(43) Pub. Date: Jan. 4, 2007

(54) High-purity pyrogenically prepared silicon dioxide

(76) Inventors: Hauke Jacobsen, Mobile, AL (US); Monika Oswald, Hanau (DE); Kai Schumacher, Hofheim (DE); Martin Morters, Rheinfelden (DE)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 10/571,332

(22) PCT Filed: Sep. 16, 2004
(86) PCT No.: PCT/EP04/10335

§ 371 Date: Mar. 7, 2006

(30) Foreign Application Priority Data
Sep. 17, 2003 (DE) 103 42 828.3

(51) Int. Cl. C03C 3/06; C01B 33/12; B32B 17/06; B32B 9/00; C03B 37/016; C03B 37/018

(52) U.S. Cl. 428/428; 501/54; 423/335; 65/395; 65/413

(57) ABSTRACT

High-purity pyrogenically prepared silicon dioxide having metal contents of less than 9 ppm is prepared by reacting a silicon tetrachloride having a metal content of less than 30 ppb by means of flame hydrolysis. The silicon dioxide can be utilized for the manufacture of high-purity glasses by means of the sol-gel process, which show a high-homogenity. It can be used for the production of shaped articles, which can be used as performs for the optical fiber spinning.

The invention relates to a high-purity pyrogenically prepared silicon dioxide, a process for the preparation thereof and the use thereof.

Silica glass has been able to be utilised advantageously for many purposes such as crucibles, boards and quartz tubes for the manufacture of semiconductors since it has been possible to prepare this silica glass at high purity. Silicon dioxide glass is furthermore used for glass equipment for chemistry or for photocells. It can be used for the manufacture of light-conducting fibres.

It is known to prepare silicon dioxide glass in the form of a monolith, for example, by hydrolysing silicon alkoxide, adding pyrogenic silica to the hydrolysed solution, allowing the mixture to gel, drying the gel and sintering the dry gel which is obtained (U.S. Pat. No. 4,681,615, U.S. Pat. No. 4,801,318).

Known pyrogenically prepared silicon dioxides can be utilised in the known process.

The known pyrogenic silicas have the disadvantage of still containing too many foreign elements for the particularly demanding purity requirements of the glass.

The invention provides a high-purity pyrogenically prepared silicon dioxide which is characterised by a metals content of less than 9 ppm.

In a preferred embodiment of the invention the high-purity pyrogenically prepared silicon dioxide can be characterised by the following metal contents:

| | |
|---|---|
| Li | ppb <= 10 |
| Na | ppb <= 80 |
| K | ppb <= 80 |
| Mg | ppb <= 20 |
| Ca | ppb <= 300 |
| Fe | ppb <= 800 |
| Cu | ppb <= 10 |
| Ni | ppb <= 800 |
| Cr | ppb <= 250 |
| Mn | ppb <= 20 |
| Ti | ppb <= 200 |
| Al | ppb <= 600 |
| Zr | ppb <= 80 |
| V | ppb <= 5 |

The total metal content can then be 3252 ppb (˜3.2 ppm) or less.

In an embodiment of the invention, which is further preferred, the high-purity pyrogenically prepared silicon dioxide can be characterised by the following metal contents:

| | |
|---|---|
| Li | ppb <= 1 |
| Na | ppb <= 50 |
| K | ppb <= 50 |
| Mg | ppb <= 10 |
| Ca | ppb <= 90 |
| Fe | ppb <= 200 |
| Cu | ppb <= 3 |
| Ni | ppb <= 80 |
| Cr | ppb <= 40 |
| Mn | ppb <= 5 |
| Ti | ppb <= 150 |
| Al | ppb <= 350 |
| Zr | ppb <= 3 |
| V | ppb <= 1 |

The total metal content can then be 1033 ppb (1.03 ppm) or less.

The invention also provides a process for the preparation of the high-purity pyrogenically prepared silicon dioxide, which is characterised in that silicon tetrachloride is in known manner reacted in a flame by means of high-temperature hydrolysis to give silicon dioxide, and a silicon tetrachloride is used here which has a metal content of less than 30 ppb.

In a preferred embodiment of the invention a silicon tetrachloride can be used which has the following metal contents in addition to silicon tetrachloride:

| | |
|---|---|
| Al | less than 1 ppb |
| B | less than 3 ppb |
| Ca | less than 5 ppb |
| Co | less than 0.1 ppb |
| Cr | less than 0.2 ppb |
| Cu | less than 0.1 ppb |
| Fe | less than 0.5 ppb |
| K | less than 1 ppb |
| Mg | less than 1 ppb |
| Mn | less than 0.1 ppb |
| Mo | less than 0.2 ppb |
| Na | less than 1 ppb |
| Ni | less than 0.2 ppb |
| Ti | less than 0.5 ppb |
| Zn | less than 1 ppb |
| Zr | less than 0.5 ppb |

Silicon tetrachloride having this low metal content can be prepared according to DE 100 30 251 or according to DE 100 30 252.

The chief process for the preparation of pyrogenic silicon dioxide, starting from silicon tetrachloride which is reacted in mixture with hydrogen and oxygen, is known from Ullmanns Enzyklopadie der technischen Chemie, 4^{th} edition, Vol. 21, pp. 464 et seq. (1982).

The metal content of the silicon dioxide according to the invention is within the ppm range and below (ppb range).

The pyrogenically prepared silicon dioxide according to the invention can be utilised in very widely varied glass manufacturing methods such as, for example, the sol-gel process. Such sol-gel processes are known from U.S. Pat. No. 4,681,615 and U.S. Pat. No. 4,801,318.

The pyrogenically prepared silicon dioxide according to the invention is advantageously suitable for the manufacture of special glasses having excellent optical properties. The glasses manufactured by means of the silicon dioxide according to the invention have a particularly low adsorption in the low UV spectrum.

Further on the present invention relates to a highly homogeneous SOi₂ glass prepared through a sol-gel procedure.

The sol-gel term defines a wide variety of processes which, even if being different as for as the working details or the reagents are concerned, are characterized by the following common operations:
preparation of a solution, or a suspension, of a precursor formed by a compound of the element (M) the oxide of which has to constitute the final glassy article;
hydrolysis, acid or base catalyzed, of the precursor, inside the solution or suspension, to form M-OH groups according to the reaction
   MXₙ+nH₂O→M(OH)ₙ+nHX
wherein X generally is an alcohol residue and n means the element M valence; the alcoxydes M(OR)n can be replaced by soluble salts of the element M such as chlorides or nitrates, and, the high-purity pyrogenically prepared silicondioxide, characterised by a metal content of less than 9 ppm. The obtained mixture, i.e. a solution or a colloidal suspension, is named sol;
polycondensation of the M-OH groups according to the reaction
   M-OH+M-OH→M-O-M+H₂O
which requires a time from few seconds to some days, depending on the solution composition and the temperature; during this step, a matrix is formed called, case by case, alcohogel, hydrogel or more generally, gel;
gel drying till the formation of a porous monolithic body; during this step, the solvent is removed through a simple controlled evaporation, which determines the so called xerogel, or through an extraction in autoclave which determines the so called aerogel; the obtained body is a porous glass, which may have an apparent density of 10% to about 50% of the theoric density of the oxide having the same composition; the dried gel can be industrially used as such;
densification of the dried gel by a treatment at a temperature, generally ranging between 800° C. and 1500° C., depending on the gel chemical composition and the preceding step process parameters; during this step the porous gel is becoming dense, under a controlled atmosphere, till to obtain a glassy or ceramic compact oxide having the theoric density, with a linear shrinkage equal to about 50%.

The final densification let a glassy product be obtained having good general characteristics, and, however, without any such optical homogeneity property to let the material be crossed by the transmitted light wave front without any suffered distortion.

The Applicant has found that in the case suitable treatments under controlled atmosphere are carried out during the densification stage, the final glassy product is obtained having no streak and strip, the same being consequently characterized by an almost total homogeneity.

Therefore, the object of the present invention is a silica glass characterized, inter alia, by the following specific properties:

light internal transmittance in the wave length between 185 nm and 193 nm higher than 85%
light internal transmittance in the wave length between 193 nm and 2600 nm higher than 99.5%
light internal transmittance in the wave length between 2600 nm and 2730 nm higher than 99%
light internal transmittance in the wave length between 2730 nm and 3200 nm higher than 85%
no streak, material of class 4 or better according to the rule DIN ISO 10110-4
no strip
no signal in the shadography (no shadow or intensity change)
   such a silica glass being prepared according to a sol-gel process using the high-purity pyrogenically prepared silicondioxide, characterised by a metal content of less than 9 ppm, wherein, in the meanwhile the densification is achieved, a treatment is carried out by means of an atmosphere containing water traces.

As further subject of the invention relates to articles, characterized by particular shapes, constituted by silicon oxide as such or suitably added, and obtained by molding at room temperature through sol-gel procedures. Particularly the present invention relates to articles having a shape which is obtained by means of suitable moulds employed within the route of a sol-gel procedure and selected on the ground of the aimed final use, such a shape allowing the same to be utilized in many fields: of particular interest is the preparation of preforms cut out for optical fiber spinning.

According to the above said sol-gel-route, it is possible to prepare monoliths of the interesting material by pouring sol onto a suitable mould, or films by pouring sol onto a suitable substrate, or preforms of optical fibers.

With specific reference to these latter, it is known that such fibers, largely employed in the telecommunication field, are constituted by a central portion, the so called “core”, and by a coating around the core, generally named “mantle”. A difference ranging about from 0.1% to 1% between the core and the mantle refraction indexes let light be confined in the core. Such a difference in the refraction index is obtained through different chemical composition of the core and the mantle.

Even if many combinations are evaluated, the most common is constituted by a glassy core formed by silicon oxide doped by germanium oxide (GeO₂—SiO₂) surrounded by a glassy SiO₂ mantle. The widest used optical fibers are of the monomodal kind, being characterized by one only allowed optical path. Such fibers generally owns a core with a 4-8 μm diameter and a mantle external diameter of 125 μm.

The most important parameter to evaluate the quality of a fiber is the relevant optical fading out, which is mainly due to light absorbing and diffusion mechanisms and is measured in decibel for kilometer (dB/Km).

As the skilled people know, UV fading out is mainly due to the absorption by the cations (as the transition metal cations) present in the fiber core, while the IR fading out is mainly due to the absorption by —OH groups which may be in the glass. The fading out of light having an intermediate wave length between UV and IR is mainly due to diffusion phenomena caused by fluctuations of the refraction indexes because of the glass unhomogeneity, of the fiber structure defects, such as imperfections in the core-mantle contact surface, fiber bubbles or breaks, or impurities inglobed within the fiber during the production process.

The optical fiber are prepared by bringing a preform to temperatures of about 2200° C. The preform is an intermediate in the fiber production, formed by an internal rod and an external coat corresponding to core and mantle of the final fiber. The ratio between the coating and rod diameters is equal to the one between the mantle and the core diameters in the finale fiber. Hereinafter, the words rod and core will be respectively used with reference to the inner part of the preform and the final fiber, while the word mantle will be used to indicate the external part either of the preforms or of the fibers.

It is known that the mantle of the preforms for the commercially available optical fibers is produced according to modifications of the ground chemical deposition process from the vapor phase (better known as “Chemical Vapor Deposition” or the acronyme “CVD”). All processes deriving from CVD make generally use of gaseous mixtures comprising oxygen (O₂) and silicon chloride (SiCl₄) or germanium chloride (GeCl₄) into an oxy-hydrogen flame to produce SiO₂ and GeO₂ according to the reactions:
SiCl₄(g)+O₂(g)SiO₂(s)+2Cl₂(g) (I)
GeCl₄(g)+O₂(g)GeO₂(s)+2Cl₂(g) (II)

The oxydes produced thereby can be deposited as particles onto a cylinder carrier which is then removed or, as an alternative, onto the inner surface of a silica cylinder carrier which is then processed to form the mantle of the final fiber.

The CVD based processes are suitable to produce optical fiber with 0.2 dB/Km minimum fading out (for transmitted light with 1.55 μm wave length), and are the state of the art in the field.

Even if these producing methods are quite satisfactory as to the performance of the resulting fibers, the yields are limited thus increasing the production costs.

It is also well known that, during the thermal treatments to achieve the complete densification of the dry gel, it is possible to carry out chemical purification thereof. Through such treatments it is possible to take advantage from the dry gel porosity to carry out washing operations in the gaseous phase in order to remove organic impurities caused to be present in the gel because of the organometallic precursors (as the previous mentioned TMOS and TEOS), as well as water, hydroxul groups linked to the cations in the gel network, or undesired metal atoms.

Generally, the removal of organic impurities is obtained through a calcination carried out by flowing an oxidizing atmosphere (oxygen or air) into the dry gel at temperatures lower than 900° C., particularly between 350° C. and 800° C.

The removal of water, hydroxyl groups and undesired metals is carried out by letting the gel pores be flowed by Cl₂, HCl or CCl₄, eventually mixtures with inert gases as nitrogen or helium, at temperatures between about 400° C. and 800° C.

The last operation is usually a washing treatment, carried out with inert gases like nitrogen, helium or argon, to totally remove chlorine or chlorine containing gases from the gel pores. At the end of these treatments, gel is densified to the corresponding glass, totally dense (hereinafter such state will be designated also as “theoric density”) by heating at temperatures higher than 900° C., and usually higher than 1200° C., under a helium environment.

The above described treatments are quite suitable to purify gels so that the resulting glasses are suitable to be largely used (generally to build optical or mechanical parts). However, it has been found that these treatments cause the presence of gaseous compounds in the final glass. In case of processing the same in the temperature range of 1900 to 2200° C. in order to draw the fibers, those gaseous compound traces give rise to microscopic bubbles which become fracture starting points, thus causing the fiber to break and the known processes to be not suitable to produce optical fibers.

The present invention allows the preparation of preforms suitable to spin optical fibers without the above said drawbacks, such fibers having characteristics equal to and sometimes higher than the ones achievable by means of the CVD technology. Moreover, the present invention relates to, according to a broad meaning, the preparation of articles having the shape desired in relation with the final use, constituted by silicon oxide, as such as suitably additivated, and comprising the above said optical fibers preforms and, furtherly, liquid safety containers, transparent (and not) devices to be used in the chemical laboratories, vessels, and, more generally, vitreous products appointed at furnishing.

Therefore, the present invention refers to particularly shaped articles constituted by silicon oxide, as such or suitably additivated, prepared by molding at room temperature according to the process comprising the following operations:
preparation of a sol starting from a silicon alcoxide, or from a silicon alcoxide and at least a precusor of at least one of the additional elements;
hydrolysis of the sol obtained thereby;
addition of colloidal high-purity pyrogenically prepared silicondioxde, characterised by a metal contenct of less than 9 ppm, according to the invention;
pouring the resulting mixture into the desired mould;
sol gelling and fast removal of the solid product;
gel drying;
gel densification by means of a thermal treatment at temperature ranging from 900° C. to 1500° C.

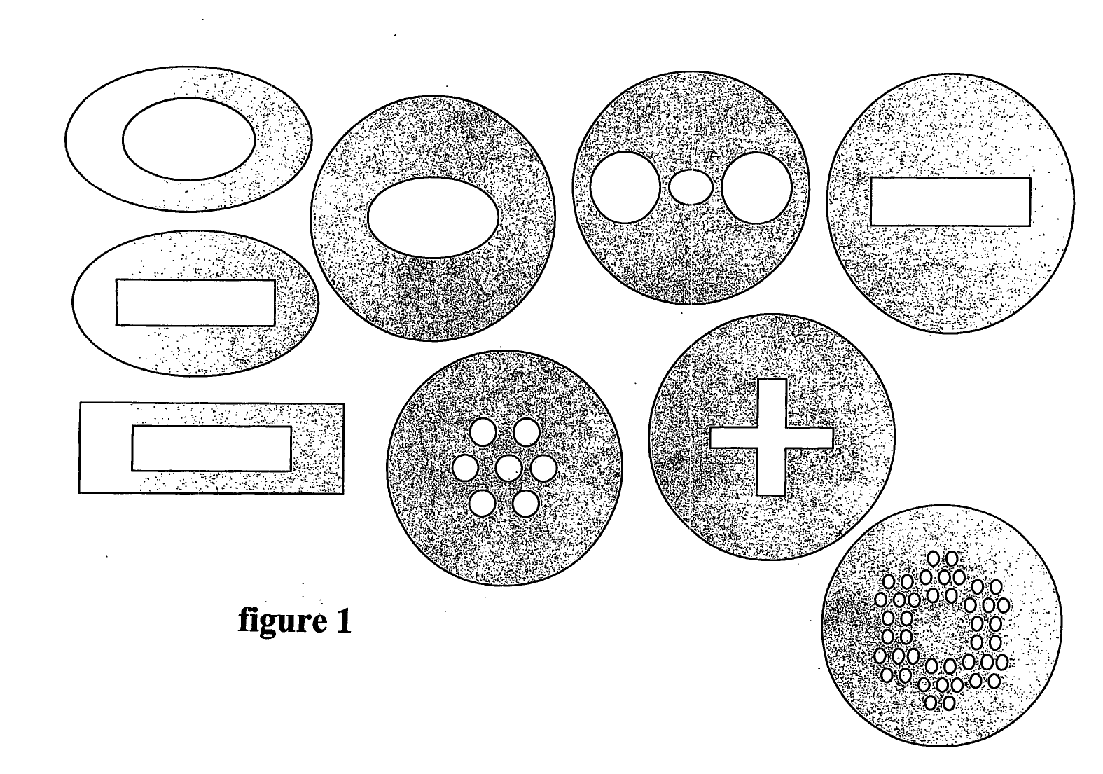

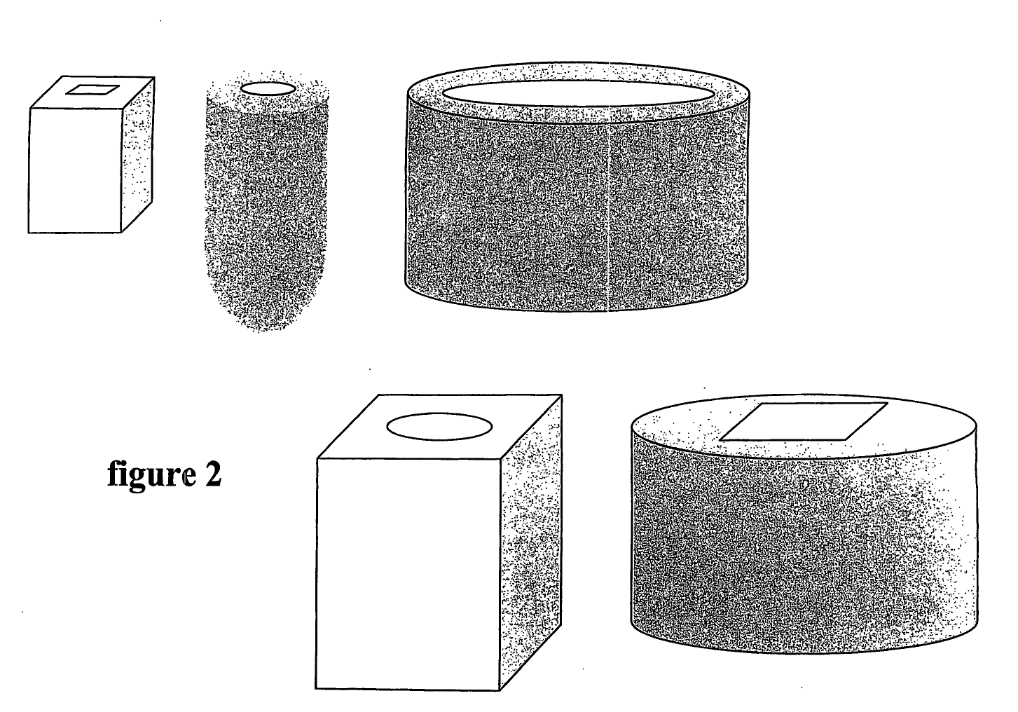

Preferred silicon alcoxides are tetramethylortosilicate and tetraethylortosilicate. When one or more additives are to be added, the same are selected by the people skilled in the art dependently upon the final purposes, the preferred one being chosen among the elements of the IIIa, IVa, Va, IIIb, IVb, Vb Groups of the Periodic Table. Even the mould will be selected by the people skilled in the art, again dependently upon the aimed use of the final article. Illustrative examples of the present invention, no way limiting the same, are the sections reported in FIG. 1 as to the optical fiber preforms, and in FIG. 2 as to some other possible employment.

In the above mentioned sol-gel procedure, all operations till the very molding are carried out at room temperature; the gel drying can be performed under ipercritical or subcritical conditions.

### EXAMPLES

### Example 1 (Comparison Example)

500 kg/h SiCl₄ having a composition in accordance with Table 1 are evaporated at approx. 90° C. and transferred into the central tube of a burner of known design. 190 Nm³/h hydrogen as well as 326 Nm³/h air having a 35 vol. % oxygen content are introduced additionally into this tube. This gas mixture is ignited and burns in the flame tube of the water-cooled burner. 15 Nm³/h hydrogen are introduced additionally into a jacket nozzle surrounding the central nozzle, in order to prevent baking-on. 250 Nm³/h air of normal composition are moreover introduced additionally into the flame tube. After cooling of the reaction gases the pyrogenic silicon dioxide powder is separated by means of a filter and/or a cyclone from the hydrochloric acid-containing gases. The pyrogenic silicon dioxide powder is treated with water vapour and air in a deacidifying unit in order to remove adherent hydrochloric acid. The metal contents are reproduced in Table 3.

### Example 2 (Embodiment Example)

500 kg/h SiCl₄ having a composition in accordance with Table 2 are evaporated at approx. 90° C. and transferred into the central tube of a burner of known design. 190 Nm³/h hydrogen as well as 326 Nm³/h air having a 35 vol. % oxygen content are introduced additionally into this tube. This gas mixture is ignited and burns in the flame tube of the water-cooled burner. 15 Nm³/h hydrogen are introduced additionally into a jacket nozzle surrounding the central nozzle, in order to prevent baking-on. 250 Nm³/h air of normal composition are moreover introduced additionally into the flame tube. After cooling of the reaction gases the pyrogenic silicon dioxide powder is separated by means of a filter and/or a cyclone from the hydrochloric acid-containing gases. The pyrogenic silicon dioxide powder is treated with water vapour and air in a deacidifying unit in order to remove adhering hydrochloric acid.

The metal contents are reproduced in Table 3.

TABLE 1
Composition of SiCl₄, Example 1

| Al | B | Ca | Co | Cr | Cu | Fe | K | Mg | Mn | Mo | Na | Ni | Ti | Zn | Zr |
|---|---|---|---|---|---|---|---|---|---|---|---|---|---|---|---|
| ppb | ppb | ppb | ppb | ppb | ppb | ppb | ppb | ppb | ppb | ppb | ppb | ppb | ppb | ppb | ppb |
| 18 | 140 | 86 | <0.1 | 2.7 | 0.4 | 280 | 14 | — | 1.4 | — | 200 | 0.6 | 250 | | |

TABLE 2
Composition of SiCl₄, Example 2

| Al | B | Ca | Co | Cr | Cu | Fe | K | Mg | Mn | Mo | Na | Ni | Ti | Zn | Zr |
|---|---|---|---|---|---|---|---|---|---|---|---|---|---|---|---|
| ppb | ppb | ppb | ppb | ppb | ppb | ppb | ppb | ppb | ppb | ppb | ppb | ppb | ppb | ppb | ppb |
| <1 | <30 | <5 | <0.1 | <0.2 | <0.1 | <0.5 | <1 | <1 | <0.1 | <0.2 | <1 | <0.2 | <0.5 | <1 | <0.5 |

TABLE 3
Metal contents of silicon dioxides (ppb)

| | | | | | Example 1 |
|---|---|---|---|---|---|
| | | | | | Comparison |
| | | | | | Example |
| | | | | | Aerosil ® |
| [ppb] | Example 2a | | Example 2b | | OX50 |
| Li | 0.8 | <=10 | 0.5 | <=1 | <100 |
| Na | 68 | <=80 | 49 | <=50 | <1000 |
| K | 44 | <=80 | 46 | <=50 | 10 |
| Mg | 10 | <=20 | 10 | <=10 | <200 |
| Ca | 165 | <=300 | 89 | <=90 | 190 |
| Fe | 147 | <=800 | 192 | <=200 | <100 |
| Cu | 3 | <=10 | <3 | <=3 | <100 |
| Ni | 113 | <=800 | 79 | <=80 | <200 |
| Cr | 47 | <=250 | 37 | <=40 | <100 |
| Mn | 3 | <=20 | 2 | <=5 | <100 |
| Ti | 132 | <=200 | 103 | <=150 | 5600 |
| Al | 521 | <=600 | 350 | <=350 | 780 |
| Zr | 3 | <=80 | <3 | <=3 | <100 |
| V | 0.5 | <=5 | <0.5 | <=1 | <500 |
| | Σ 1257 | Σ 3255 | Σ 964 | Σ 1033 | Σ 9080 |
| | ppb = | ppb = | ppb = | ppb = | ppb = |
| | 1.26 ppm | 3.2 ppm | 0.96 ppm | 1.03 ppm | 9.08 ppm |

Measuring Method

The pyrogenically prepared silicon dioxides which are obtained are analysed as to their metal content. The samples are dissolved in an acid solution which comprises predominantly HF.

The SiO₂ reacts with the HF, forming SiF₄+H₂O. The SiF₄ evaporates, leaving behind completely in the acid the metals which are to be determined. The individual samples are diluted with distilled water and analysed against an internal standard by inductively coupled plasma-atomic emission spectroscopy (ICP-AES) in a Perkin Elmer Optima 3000 DV. The imprecision of the values is the result of sample variations, spectral interferences and the limitations of the measuring method. Larger elements have a relative imprecision of +5%, while the smaller elements have a relative imprecision of +15%.

1-11. (canceled)

12. High-purity pyrogenically prepared silicon dioxide, having a metal content of less than 9 ppm.

13. The high-purity pyrogenically prepared silicon dioxide according to claim 12, having the following metal contents:

| | |
|---|---|
| Li | ppb <= 10 |
| Na | ppb <= 80 |
| K | ppb <= 80 |
| Mg | ppb <= 20 |
| Ca | ppb <= 300 |
| Fe | ppb <= 800 |
| Cu | ppb <= 10 |
| Ni | ppb <= 800 |
| Cr | ppb <= 250 |
| Mn | ppb <= 20 |
| Ti | ppb <= 200 |
| Al | ppb <= 600 |
| Zr | ppb <= 80 |
| V | ppb <= 5 |

14. The high-purity pyrogenically prepared silicon dioxide according to claim 13, wherein the total metal content can be 3252 ppb.

15. The high-purity pyrogenically prepared silicon dioxide according to claim 12, having the following metal contents:

| | |
|---|---|
| Li | ppb <= 1 |
| Na | ppb <= 50 |
| K | ppb <= 50 |
| Mg | ppb <= 10 |
| Ca | ppb <= 90 |
| Fe | ppb <= 200 |
| Cu | ppb <= 3 |
| Ni | ppb <= 80 |
| Cr | ppb <= 40 |
| Mn | ppb <= 5 |
| Ti | ppb <= 150 |
| Al | ppb <= 350 |
| Zr | ppb <= 3 |
| V | ppb <= 1 |

16. The high-purity pyrogenically prepared silicon dioxide according to claim 15, wherein the total metal content is 1033 ppb.

17. Process for the preparation of the high-purity pyrogenically prepared silicon dioxide according to claim 12, comprising reacting silicon in a flame in a high-temperature hydrolysis to give silicon dioxide, wherein the silicon tetrachloride has a metal content of less than 30 ppb.

18. The process for the preparation of the high-purity pyrogenically prepared silicon dioxide according to claim 17, wherein the silicon tetrachloride has the following metal contents:

| | |
|---|---|
| Al | less than 1 ppb |
| B | less than 3 ppb |
| Ca | less than 5 ppb |
| Co | less than 0.1 ppb |
| Cr | less than 0.2 ppb |
| Cu | less than 0.1 ppb |
| Fe | less than 0.5 ppb |
| K | less than 1 ppb |
| Mg | less than 1 ppb |
| Mn | less than 0.1 ppb |
| Mo | less than 0.2 ppb |
| Na | less than 1 ppb |
| Ni | less than 0.2 ppb |
| Ti | less than 0.5 ppb |
| Zn | less than 1 ppb |
| Zr | less than 0.5 ppb |

19. An article of glass made from the high-purity pyrogenically prepared silicon dioxide according to claim 12.

20. A process for the manufacture of glass by the sol-gel process employing the high-purity pyrogenically prepared silicon dioxide according to claim 12.

21. Silica glass characterized by the following specific properties:
light internal transmittance in the wave length between 185 nm and 193 nm higher than 85%
light internal transmittance in the wave length between 193 nm and 2600 nm higher than 99.5%
light internal transmittance in the wave length between 2600 nm and 2730 nm higher than 99%
light internal transmittance in the wave length between 2730 nm and 3200 nm higher than 85%
no streak, material of class 4 or better according to the rule DIN ISO 10110-4
no strip
no signal in the shadography (no shadow or intensity change)
said silica glass having been prepared according to a sol-gel process using the high-purity pyrogenically prepared silicon dioxide, having a metal content of less than 9 ppm, wherein, densification is achieved and a treatment is carried out by means of an atmosphere containing trace amounts of water.

22. A shaped article comprising silicon oxide prepared by room temperature molding according to a process comprising:
preparing a sol from a silicon alkoxide, or from a silicon alkoxide and at least a precursor of at least one of an additional element;
hydrolyzing of the sol obtained thereby;
adding colloidal high-purity pyrogenically prepared silicon dioxide, having a metal content of less than 9 ppm to form a mixture;
pouring the resulting mixture into a desired mold;
sol gelling the mixture to form a solid product and quickly removing the solid product from said mold;
gel drying the solid product;
gel densifying the solid product by a thermal treatment at temperature ranging from 900° C. to 1500° C.

23. A preform for optical fiber spinning made from the shaped article of claim 22.

24. An article according to claim 22, having a shape shown in FIG. 1.

25. An article according to claim 24, having a shape shown in FIG. 2.
